(19) United States
(12) Patent Application Publication
(10) Pub. No.: US 2003/0027549 A1
(43) Pub. Date: Feb. 6, 2003

(54) Prepaid communication system and method

(75) Inventors: Rafael Kiel, Modi'in (IL); Alexander Grinshpun, Tel Aviv (IL); Offer Sharon, Asseret (IL); Meir Lasry, Tel-Mond (IL); Ran Bittmann, Tel Aviv (IL)

Correspondence Address: BROWDY AND NEIMARK, P.L.L.C., 624 NINTH STREET, NW, SUITE 300, WASHINGTON, DC, 20001-5303, US

(73) Assignee: MSAFE INC., Wilmington, DE (US)

(21) Appl. No.: 09/917,216

(22) Filed: Jul. 30, 2001

(51) Int. Cl. H04M 11/00

(52) U.S. Cl. 455/405; 455/407

(57) ABSTRACT

Provided are method and system for applying a prepaid credit to use by a client in his communication activity as well as for managing a prepaying scheme for the client. A client's communication device, for example, wireless communication device of a cellular telephone system or a computer communicating over a computer network such as the Internet, is provided with an activity monitoring unit that holds the client's credit data and applies such credit to permit communication activity by the client through the use of the client's communication device.

### FIELD OF THE INVENTION

The present invention is generally in the field of communication and relates to a system and method in which a client prepays for his subsequent communication activity. Such billing will be referred to herein at times as “prepayment scheme”.

### BACKGROUND OF THE INVENTION

Wireless communication is likely the most rapid developing communication infrastructure. Wireless communication systems includes in particular cellular telephone and pager systems. Together with the rapid increase in use of cellular telephone systems throughout the world, the scope of use of cellular telephones is changing from a medium dedicated purely to voice communication, to a medium used also for a wide variety of other applications. In particular, modern cellular telephones are installed with Internet access ability, making use of protocols such as the Wireless Application Protocol (WAP) developed therefor, while cellular telephone operators are beginning to provide a gateway through the cellular telephone networks to the Internet.

One of the most popular billing schemes in use today is a prepayment scheme, where the client pays up front for credit applied against future use of communication services. This credit is then used in essentially such time to pay for the communication services as these are used by the client. Prepayment scheme requires real time monitoring of the credit available to the client in order to be able to terminate the service to the client when the client reaches his credit limit. Currently, prepaid billing systems are limited to provision of credit against communication time-based billing, for example, “air time” in cellular communication. With the introduction of the next generation of cellular communication, air time becomes only one of the basis for billing that include billing dependent on transmitted or received data packets, content-based billing, location-based service billing, quality of service-based billing, etc. This places a heavy burden on prepayment scheme systems in view of the need to continuously monitor the communication activity in real time. In cellular telephone systems the problem is particularly complex in view of the need to continue to monitor the communication activity in real time as the client moves from one cell to another.

Currently, there are several methods for prepayment schemes in operation. One method, uses call forwarding to route call to a prepaid server, which then verifies the client's credit. The call is then routed back to the mobile network for completion. The server then updates the credit in real time during the call. Credit can be purchased either directly from the communication service provider (SP) or by purchasing a prepaid card from a kiosk.

In another method, the client's credit is stored on a SIM (subscriber identity module) card. The SIM card updates the credit according to the operator's tariff. Replenishment is currently via a voice call to a prepayment server, by entering a code, for example, using a DTMF (dual tone multi frequency) tone dialing. The credit is then sent as an SMS (short messaging services) message to the SIM card.

In another method, a billing server is used to handle the prepayment scheme services. When a call is tempted, the switch refers the transaction to a billing server, which then verifies the client's credit. If in credit, the call is authorized. The billing system records the credit used during the call and updates the credit after the call has ended. In the event of the client using more credit than he has, the system records this and assigns the client minus credit. The billing system then informs the switch not to provide service to the client until authorized by the billing system. When the client purchases more credit, the billing system authorizes the switch to resume service to the client.

In another method the prepayment scheme is integrated into a system switch. When a call is attempted, the switch verifies that the client has enough credit and then completes the call. The switch then updates the client's balance in real time during the call.

### SUMMARY OF THE INVENTION

The present invention provides a novel method and system for conveniently monitoring credit level in a client's prepayment scheme account which is then continuously debited in essentially real time for the client's communication activity. In accordance with the invention the client communication device comprises a communication activity-monitoring unit which may be a hardware device, a software utility or a combination of the two and which probes, records and typically also stores data relating to the activity performed by the client's communication device. Such communication activity includes, for example: use of the wireless communication network in general, e.g. communication time or utilized bandwidth; utilization of special services, e.g. access to a computer network such as the Internet, to which a gateway is provided by the wireless communication service provider (to be referred to herein as the “service provider”); access of specific sites of the computer network that require payment for such access; purchase of products, services, content or data from sites of the computer network; payment made to the client, for example, in case of a win in a network gaming activity; etc. The activity-monitoring unit has a data storage that stores data that includes a client credit data record and a client-associated billing rules. Based on said billing rules, the activity-monitoring unit calculates a debit to the client for the communication activity, and continuously updates the client credit data record. Once the client credit data record runs out of credit, the communication activity may be terminated.

The invention thus provides a method for applying a prepaid credit of a client for the client's communication activity through use of a client communication device. The communication device, typically a wireless communication device, is installed with or is connected to an activity-monitoring unit that can record communication activity of the communication device. The activity-monitoring unit has also a data storage that stores data that includes a client credit data record and client-associated billing rules. The unit continuously monitors the communication activity of the communication device, calculates a billing amount based on the communication activity and said billing rules. The unit permits the communication activity to proceed until the credit has been exhausted upon which the unit can terminate the communication activity.

The invention also provides a method for managing a prepayment scheme account of a client. The client credit data of the client is transmitted, from a prepayment scheme server utility to said activity-monitoring unit that continuously monitors the communication activity of the communication device, calculates a billing amount based on the communication activity and the billing rules, and permits communication activity to proceed until the credit has been exhausted. Once the credit bas been exhausted, the communication activity will be terminated.

Preferably, the communication activity between the activity-monitoring unit and the prepayment scheme server utility may be bi-directional. Namely, rather than only receiving credit data, the activity-monitoring unit can induce the transmission of utilized or still available credit to the prepayment scheme server utility.

As can be appreciated, the communication of available credit between the prepayment scheme server utility and the activity-monitoring unit is in a client non-controlled (and preferably non-controllable) communication session. This is important in order to ensure integrity of the credit data.

In accordance with another aspect of the invention there is provided a system for managing a prepayment scheme account of a client, the credit being used for payment of communication activity of the client carried out over a communication infrastructure. The system comprises a prepayment scheme server utility that can receive and store credit data for the client. The client communication device, that communicates over the communication infrastructure, has included therein, or is connected to an activity-monitoring unit of the kind specified above. The unit receives the client-related credit data from said server utility and is transmitted to said communication device over the communication infrastructure. When a communication activity is in progress the unit continuously monitors communication activity and calculates a billing amount based on the communication activity and the billing rules. The unit permits the communication activity to proceed until the client credit has been exhausted.

### BRIEF DESCRIPTION OF THE DRAWINGS

The attached drawings show specific, illustrative embodiments, of the invention. These illustrated embodiments are intended to exemplify the present invention which should not be construed as limiting the scope of the invention in any way.

In the drawings:

FIG. 1 illustrates, by way of block diagram, the main components of the system of the invention.

FIG. 2 shows another embodiment of the system in accordance with the invention.

FIGS. 3A-3B are, in combination, a flow chart showing the manner of carrying out the method of the invention in accordance with one embodiment thereof.

### DETAILED DESCRIPTION OF THE INVENTION

The present invention provides a novel method and system for use in charging schemes for charging a client based on his communication activity, where a client prepays a credit amount which is subsequently applied against his communication activity carried out over the communication infrastructure.

The term “communication infrastructure” used above and below includes all components of a communication system that is involved in the provision of communication service to a client communication device. In the case of a cellular telephone system, for example, the communication infrastructure includes the base stations of the various cells, a cellular telephone switching office that has all the phone connections of the cellular communication devices that communicate with a base station that is linked to the cellular telephone switching office, central control system that coordinates activity and supports central offices, etc. In case of a line telephone system, a communication infrastructure includes the cabling, the central office, etc. The communication infrastructure may also be a computer network in which case the communication devices are computerized devices that are linked to and communicate over the computer network.

The invention provides a novel solution to the problem of real time monitors of communication activity needed for the purpose of billing a client's prepayment scheme account. In accordance with the invention, rather than continuously monitoring the communication activity of a client by utilizing central system resources, the activity is recorded by an activity-monitoring unit that is installed in the client's communication device. Said unit serves functionally as an extension of the prepayment scheme server utility. Such a device continuously monitors the communication activity and continuously determines whether the client has still available credit for his communication activity or whether the credit has been exhausted. In the latter case, the communication activity may be terminated by said unit.

Thus, the method and system of the invention require considerably less resources of the communication system infrastructure as compared to existing or prior art prepayment schemes method and systems. Through this unique solution, the invention permits to more accurately manage the client's prepayment scheme account. This is particularly advantageous in case of charging schemes for communication activities which are based on other than pure communication time such as the case of billing dependent on transmitted or received data packets, content-based billing, location-based service billing, quality of service-based billing, and others.

Another important feature of carrying out the invention is that a scale-up of the communication infrastructure is not limited by the billing system, that lends itself to easy scale-up. In fact, the communication system resources needed for managing prepayment scheme client accounts, are far less dependent on the number of clients as compared to prior art systems.

The prepayment scheme method and system of the invention, are particularly applicable to cellular telephone systems, although not limited thereto. In the following, the invention will be illustrated occasionally by reference to cellular telephone systems it being understood that this is not intended to be limiting but rather to serve as an illustration, by way of example, of the invention. In a cellular system, the invention has another important feature in that it is easier, in accordance with the method of the invention, to monitor clients available credit during a communication session, where the client moves from one cell to another (a major difficulty in prepayment scheme-based billing systems in accordance with the prior art).

The activity monitoring unit may be installed within the client communication device or may be connected thereto. For example said unit may be a hardware utility, a software utility or a combination of both. The unit may be incorporated within the cellular modem.

The communication activity monitored by the activity-monitoring unit may include the extent of use of the communication device (for example, communication time), the extent of communication traffic with the communication device, e.g. the number of data packets transmitted to or from the communication device. The monitored communication activity may also include content of received data. For example, in case of access to and navigation in a computerized network, the monitored communication activity may be, for example, the time spent navigating through the network, for charging the client based on such time signal; access by the client to sites of the network which require payment for access; the amount of bits (or bytes) or data packets transmitted to or from the communication device for a bill-by-bid (or bill-by-byte) or bill-by-data packets charging basis; the bandwidth used for a specific communication activity; etc. In addition, the monitored communication activity may be transactions performed by the client, using his communication device, for example, purchasing a product service, data or content.

The transmission of credit data between the activity-monitoring server utility and the activating monitoring unit is preferably performed automatically in a manner not controlled by the client. This ensures integrity of the credit data transfer between the two. Such a transmission may be in a communication session initiated by said server utility or by said activity-monitoring unit. The exchange of data between said unit and said server utility may involve standard handshake protocols and will be typically in an encrypted form. The transmission protocols and method of encryption that are used may be such that they are known per se, and are thus readily available to a person versed in the art.

The term “activity-monitoring server utility” should be understood in the functional sense, namely, as a hardware/software combination that performs the functions as defined and explained herein. Said server utility may be comprised of one or more independent servers; or may be comprised within or integrated within the system of the communication service provider. Said server utility may be linked to an independent modem unit that communicates with all the activity monitoring units of the communication devices through the communication infrastructure. Alternatively, its communication interface may be integrated with the communication system infrastructure. As may readily be appreciated by the artisan, the invention is not restricted to any specific system architecture and any system having functions such as these defined and described above, and further below, is within the scope of the invention.

The activity monitoring unit typically comprises a data encryption module, for example an asymmetric data encryption standard accelerator for boosting performance of public key infrastructure (PKI) and secure a connection handshake and sign a document or certificate, or for example a symmetric data encryption standard for accelerating secure (encrypted) data transmission between the unit and the said server utility. Asymmetric data encryption standard accelerators include, for example, elliptic curve cryptography (ECC) accelerator, Rivest, Shamir and Adleman (RSA) accelerator, a Diffie-Helman (DM) accelerator, a multi-prime (MP) accelerator, and others. Symmetric data encryption standard accelerators are for example Data Encryption Standard (DES) accelerator, Advanced Encryption Standard (AES) accelerator that may be used in accordance with the invention and Secure Hash Algorithm 1 (SHA-1) accelerator.

The activity-monitoring unit may also comprise one or more real time clocks.

The communication device or said activating-monitoring unit may include safety features intended to block the ability to tamper with the device or with the automatic transmission feature, so as to ensure integrity of the activity data transmitted to said server utility.

### DETAILED DESCRIPTION OF SPECIFIC EMBODIMENTS

In the following description, several embodiments will be described which are intended to illustrate the invention and which should not be construed as limiting the invention in any way. The invention will be illustrated hereinbelow and particular emphasis on the invention as applied to prepayment schemes in similar telephone systems. It should be understood that the invention is not limited to this application and may equally be applied to any form of communication as can no doubt be readily be appreciated by a person versed in the art.

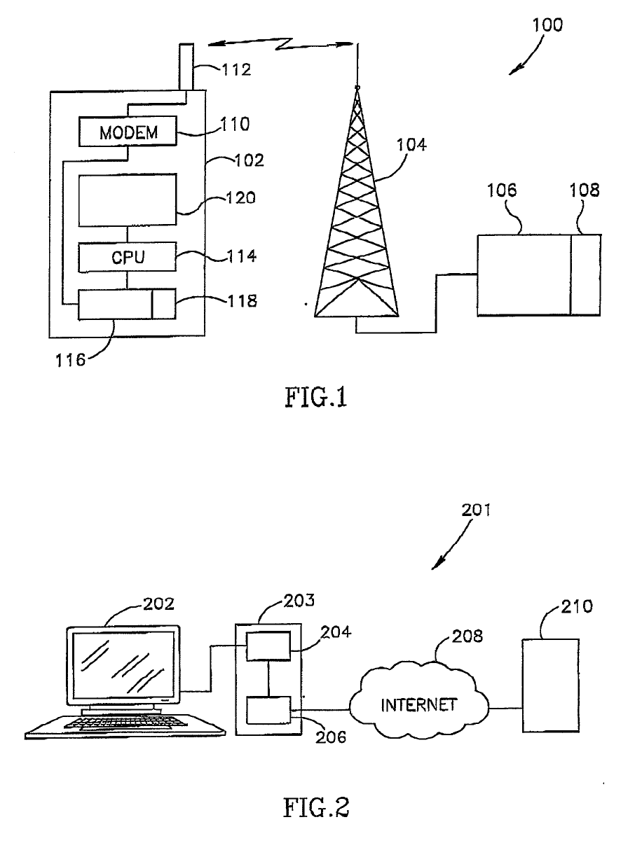

FIG. 1 illustrates a system 100 in accordance with one embodiment of the invention. Shown is a handheld cellular communication device 102 which communicates with an antenna 104, of a specific cell, which is linked to the cellular telephone infrastructure shown schematically as blade 106. Included within this infrastructure is a prepayment scheme server utility 108. As will no doubt be appreciated, the system 100 includes many client communication devices such as device 102 while only one being shown for ease of illustration.

Handheld communication device 102 includes a modem 110 connected to antenna 112, a CPU 114, an activity monitoring unit 116. Activity monitoring unit 116 monitors the incoming and outgoing communication. Unit 116 includes also a data storage 118 for storing data comprising the client credit data record and a client-associated billing rules. CPU 114 is linked to the user interface (typically a keyboard and a display) represented as block 120.

The client's credit data record may simply show the amount of units, which may be in terms of currency, arbitrary units, etc., the client has still available for payment for his communication activity. The client-associated billing rules define the charge to the client for different communication activities. The rules may include different charges for different times of days, different charges depending on the number called, a billing scheme depending on the amount of data or data packets transmitted to or from the device, billing depending on received content, etc.

The original credit data record generated in a sever utility 108 when the client applies for credit in one of a variety of ways known per se. For example, the client may, using the DTMF signaling, transmit his credit card information to the server utility over the wireless communication infrastructure. The original credit data record is then transmitted through the infrastructure to the client's handheld communication device 102 and then recorded in data storage 118. In usage, the credit data is updated continuously as the client performs communication activity using his communication device 102. When the credit is exhausted, the communication activity may be terminated over a time, depending on the particulars for a specific client. He may also be permitted to go slightly into debit, for example, in order to allow him to replenish his credit line. This credit information may be continuously or occasionally, e.g. periodically or when the credit has been exhausted, displayed to the client on the display that forms part of 120.

FIG. 2 shows another system 200. In this system a computer 202 is connected via an interface module 203, comprising an activity monitoring unit 204 and a modem 206 to the Internet 208. Typically, but not exclusively, unit 204 and modem 206 may be combined into one integral unit 203. Also typically, but not exclusively, both or unit 203, are included within the computer itself, (although shown here outside the computer for the sake of illustration) to the Internet 208. Linked to the Internet is also a prepayment scheme server utility 210. Here again, as can be appreciated, connected to the Internet may be a plurality of computers 202, each one including or being connected to a unit 203, while only one is shown for ease of illustration.

Similarly as in the case of the embodiment of FIG. 1, a credit line is established through server utility 210 and this is transmitted through the Internet to storage 212 for local storage of the credit data. Module 214 within the unit 204 continuously monitors the communication activity within the computer 202 and the Internet 208 and updates the credit data record accordingly.

In both FIGS. 1 and 2, once some credit has been used, the server utility 108 and 210 respectively, can be updated by this locally obtained information.

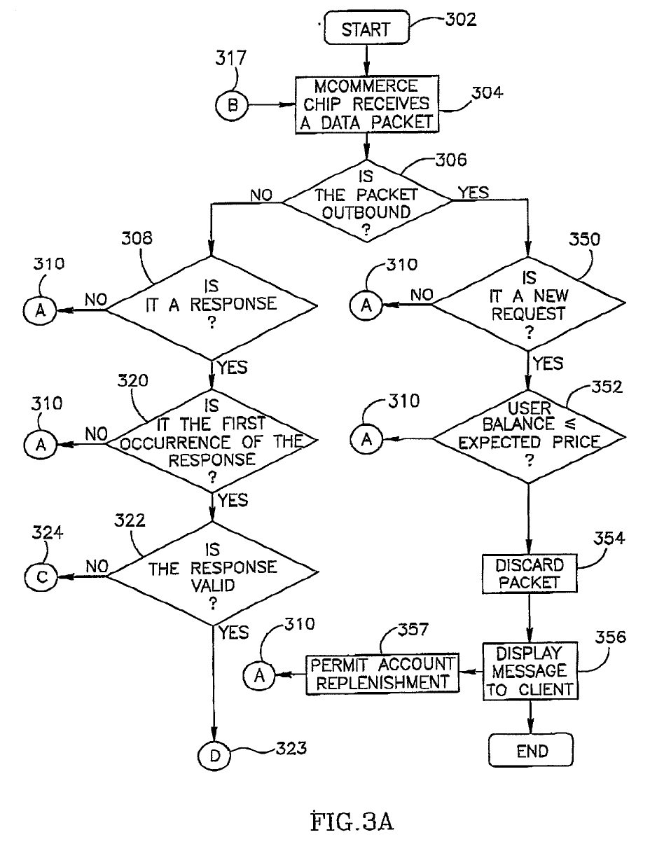

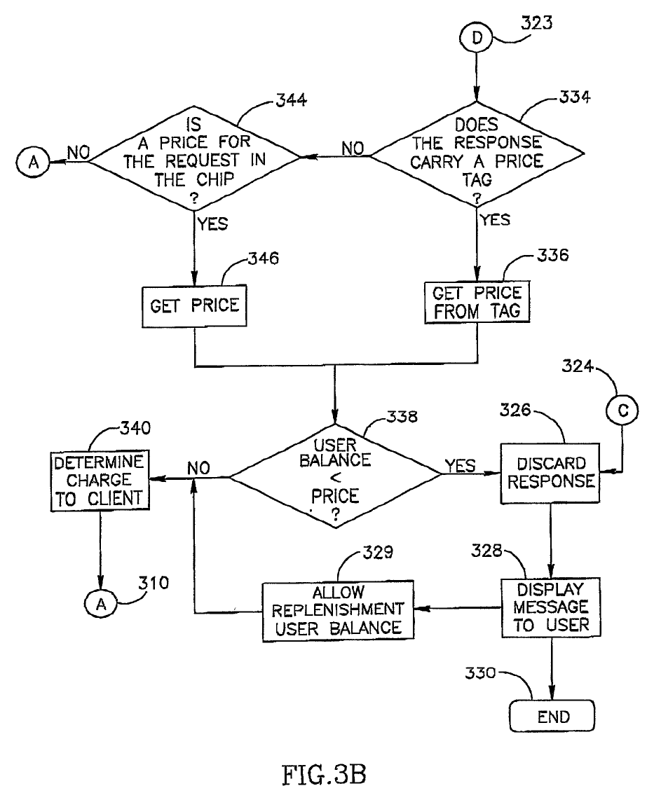

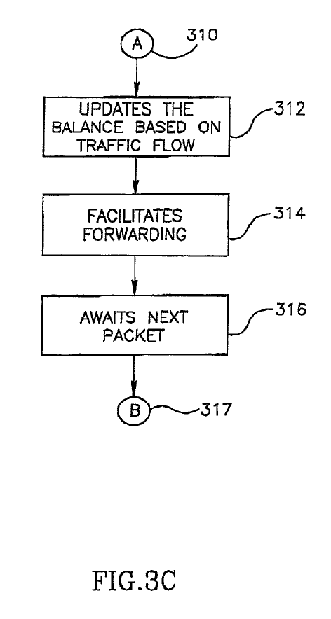

Reference is now being made to FIGS. 3A-3C, which in combination, show, by way of its flow chart, the manner of operation of the activity monitoring unit in accordance with an embodiment of the invention. This illustrated embodiment deals with an application of the invention in mobile telephones, with the monitored activity being a transmission of data packets. Such activity is referred to hereinbelow as “mCommerce” and the activity monitoring unit is referred to in the text below as “mCommerce chip”.

At the start of the mCommerce operation 302, the mCommerce chip receives at 304 a data packet, and verifies at 306 whether it is inbound directed (namely received data) or outbound. If the packet is inbound, the mCommerce chip then first determines, at 308 whether it is a response to a previously sent request or not. In the latter case the algorithm proceeds along path 310 (see FIG. 3C) in which account balance is updated at 312, based on the flow of the communication traffic. The data may be data received based on a certain client set-up profile and not in response to a specific request. Such data may either be free data, for example, an SMS message transmitted by the communication service provider to all or a group of its subscribers; or may be data for which the client is charged, for example, a news service to which the client subscribes, location-based services, etc. After updating the prepayment account, (in the case of free data, there is a zero charge made to the account at this point) the transmission of the data packet is facilitated at 314 and then the mCommerce chip is prompted, at 316, proceed towards 317 to wait for the next data packet updates the prepaid credit according to the packet-based tariff, forwards the packet to the handset and awaits the next packet.

In case the data is a response, the mCommerce chip then verifies at 320 whether it is a first occurrence of a response. If not the mCommerce chip proceeds to process data along the path 310. If in the affirmative, the chip then determines at 322 whether the response is valid and if not the processing proceeds along path 324 to discard the response at 326, and displays a message to the user at 328 and subsequently ends the transmissions at 330.

If the response is a valid one, the processing proceeds towards 323 to determine at 334 whether the response carries a price tag. If in the affirmative, the mCommerce chip determines at 336 the price from the price tag and then at 338 determines whether the user balance is below or above the price. If the client balance is above the price, namely sufficient credit still exists, the mCommerce chip then determines at 340 the charge to the client and then proceeds along path 310 described above. In case the user balance is insufficient to pay for the inbound data package, transmission is discarded at 326, and a message is displayed to the client at 328 and the transmission is terminated at 330, as described above. The client may be given the opportunity at 329 to replenish his credit account and if he so did the process proceeds towards 340 in the manner described above.

In case it is determined at 334 that the response does not carry price tag, the mCommerce chip then determines at 344 whether there is a price for the request already within the unit itself, for example, in case of charges based on a certain schedule of charges for the specific client pre-programmed or inputted previously into the mCommerce chip. If there is no price for which it is in the chip, this signifies that the data packet is free and the mCommerce proceeds along path 310 described before with a zero update to the client's account. In case the price is stored within the mCommerce chip, the price is obtained at 346 and then the user balance is checked at 338 and the procedure from there is as described above.

In case the data packet is outbound, the mCommerce chip determines, at 350 whether it is a new called request. If not, the mCommerce chip then proceeds along path 310 as described above. If it is a new request, the user account balance is checked at 352 against the expected price to transmit the outbound data packet and if the account balance is sufficient then the mCommerce chip proceeds along path 310 described before. In case the client balance is insufficient, the mCommerce chip, at 354, discards further transmission of the data packet, and then at 356 displays a message to the user. In a particular example, such the client may be prompted at 357 to replenish his credit account, for example, by inputting his credit card details and amount, which information may first be stored locally within the mCommerce chip or transmitted immediately to the prepayment scheme server utility. Then the communication is either terminated at 358 or, if the user replenished his account, permitted to proceed along path 310.

The above description relates specifically to the transmission of data packets. It would be appreciated that a similar scheme, mutatis mutandis, may be applied for a variety of other communication activities including, in particular, voice communication, where the measured quantity may be air time. Furthermore, as may also be appreciated this operation algorithm is but an example and a large number of other algorithms, implementing the features of the invention may be envisaged.

The user may purchase additional credit at any time. Upon reaching a set level of credit, the user is alerted, is requested that he or she purchases more. This can be done “over the air”, by sending the purchase request to the operator, who will then download the requested amount of credit to the handset. This credit then builds according to the use's arrangement with the seller operator.

1. A method for applying a prepaid credit of a client for the client's communication activity through use of a client communication device, comprising:
(a) installing in or connecting said communication device to an activity-monitoring unit that can record communication activity of the communication device; the activity monitoring unit having a data storage for storing data comprising client credit data record and client-associated billing rules; and
(b) said unit, continuously monitoring the communication activity of said communication device, calculating a billing amount based on the communication activity and said billing rules; said unit permitting the communication activity to proceed until credit has been exhausted.

2. A method according to claim 1, wherein said billing rules including data-packet or content-based billing rules and said communication activity includes data or content communication.

3. A method according to claim 1, wherein said communication device communicates with a prepayment scheme server utility to transmit credit data from said unit to said server utility.

4. A method according to claim 3, wherein said credit data record can be remotely updated by the prepayment scheme server utility.

5. A method according to claim 3, wherein the communication between the activity monitoring unit and the prepayment scheme server utility is in a secure mode.

6. A method according to claim 1, wherein the communication device is a client wireless communication device (WCD) communicating over a cellular network.

7. A method for managing a prepayment scheme account of a client, comprising:
(a) transmitting credit data of a client from a prepayment scheme server utility to an activity-monitoring unit that can record communication activity of the communication device; the activity monitoring unit having a data storage for storing data comprising client credit data record and client-associated billing rules; and
(b) said unit, continuously monitoring the communication activity of said communication device, calculating a billing amount based on the communication activity and said billing rules; said unit permitting the communication activity to proceed until credit has been exhausted.

8. A method according to claim 7, wherein said billing rules including data-packet or content-based billing rules and said communication activity includes data or content communication.

9. A method according to claim 7, wherein said communication device communicates with a prepaid billing server utility to transmit credit data from said unit to said server utility.

10. A method according to claim 9, wherein the communication between said unit and said server utility is in a secure mode.

11. A method according to claim 9, wherein said credit data record can be remotely updated by a credit server utility with new communication activity credit for the client.

12. A method according to claim 7, wherein the communication device is a client wireless communication device (WCD) communicating over a cellular network.

13. A system for managing a prepayment scheme account of a client, the credit being used for payment of communication activity of the client carried out over a communication infrastructure, the system comprising:
a prepayment scheme server utility that can receive and store credit data for the client;
an activity-monitoring unit installed in or connected to a client communication device, said unit can record communication activity of
